(19) United States
(12) Patent Application Publication
(10) Pub. No.: US 2010/0089690 A1
(43) Pub. Date: Apr. 15, 2010

(54) METHOD FOR MAKING AN ACOUSTIC TREATMENT COATING AND COATING THUS OBTAINED

(75) Inventors: Fabrice Gantie, Toulouse (FR); Bernard Duprieu, Toulouse (FR); Valerie Frustie, Toulouse (FR); Alain Porte, Colomiers (FR); Thomas Gilles, Toulouse (FR); Jacques Lalane, Saint Orens de Gameville (FR)

Correspondence Address: YOUNG & THOMPSON, 209 Madison Street, Suite 500, Alexandria, VA, 22314, US

(73) Assignee: AIRBUS FRANCE, Toulouse (FR)

(21) Appl. No.: 12/527,984

(22) PCT Filed: Feb. 14, 2008
(86) PCT No.: PCT/FR2008/050248

§ 371 Date: Aug. 20, 2009

(30) Foreign Application Priority Data
Feb. 20, 2007 (FR) 07 53357
Feb. 20, 2007 (FR) 07 53360

(51) Int. Cl. E04B 1/82; G06F 17/50

(52) U.S. Cl. 181/284; 700/98

(57) ABSTRACT

A process for the producing a coating for acoustic treatment relative to a leading edge such as an air intake of an aircraft nacelle, the coating including a reflective layer, an alveolar structure, and an acoustically resistive layer, includes:

Digitizing the shape of the alveolar structure that it will have when it will be installed at the surface to be treated,

Positioning in a virtual manner—so as to define their geometries—two series of bands so as to delimit a tube between, two adjacent bands of a first series, and two second adjacent bands of a second series,

Cutting out each band according to their geometries defined above,

Producing cut-outs in each band to allow the assembly of the bands,

Assembling the bands so as to obtain an alveolar structure that has shapes that are suited to the surface to be treated.

This invention relates to a process for the production of a coating for acoustic treatment incorporating an alveolar structure with a complex shape, whereby said coating is more particularly suited for covering a leading edge of an aircraft, in particular an air intake of a nacelle.

To limit the impact of the sound pollution close to airports, the international standards are increasingly restrictive as far as sound emissions are concerned.

Techniques have been developed for reducing the noise that is emitted by an aircraft and in particular the noise that is emitted by a propulsion unit by arranging, at tube walls, coatings that are intended to absorb a portion of the sound energy, in particular by using the principle of Helmholtz resonators. In a known manner, a coating for acoustic treatment, also called an acoustic panel, comprises—from the outside to the inside—an acoustically resistive porous layer, at least one alveolar structure, and a reflective or impermeable layer.

Layer is defined as one or more layers that may or may not be of the same nature.

The acoustically resistive porous layer is a porous structure that plays a dissipative role, partially transforming the acoustic energy of the sound wave that passes through it into heat. It comprises so-called open zones that are able to allow acoustic waves to pass and other so-called closed or filled zones that do not allow sound waves to pass but are designed to ensure the mechanical strength of said layer. This acoustically resistive layer is characterized in particular by an open surface ratio that varies essentially based on the engine, and components that constitute said layer.

The alveolar structure is delimited by a first imaginary surface where the acoustically resistive porous layer is able to be connected directly or indirectly and by a second imaginary surface where the reflective layer is able to be connected directly or indirectly and comprises a number of tubes that empty out, on the one hand, at the first surface, and, on the other hand, at the second surface. These tubes are sealed by, on the one hand, the acoustically resistive porous layer, and, on the other hand, the reflective layer so as to form a cell.

A honeycomb structure is used to form the alveolar structure of a coating for acoustic treatment. Different types of materials can be used for forming the honeycomb.

According to an embodiment, a honeycomb is obtained from bands that are arranged in a vertical plane that extends in a first direction, each band being connected in an alternating fashion to adjacent bands with spacing between each connecting zone. Thus, when the set of assembled bands is expanded in a direction that is perpendicular to the first direction, an alveolar panel is obtained, whereby the bands form the lateral walls of the tubes with a hexagonal cross-section. This structure makes it possible to obtain high mechanical compression and flexural strengths.

In a variant as described in the document GB-2,024,380, an alveolar structure can comprise a first series of rectangular bands and a second series of rectangular bands each comprising cut-outs that make it possible to assemble them so as to form a plane alveolar structure.

In the case of a coating for acoustic treatment, the complex is made flat; namely the acoustically resistive and reflective porous layers are connected to the alveolar structure in a flat configuration.

Hereinafter, the complex is shaped at the surface to be treated. In the case of a flat wall or a cylindrical wall of a nacelle with a large diameter, this shaping can be implemented. It is different for the tubes with small diameters or the complex surfaces, for example with two radii of curvature such as an air intake of a nacelle.

These shaping difficulties are first derived from the very nature of the alveolar panel that has a strong flexural strength. Thus, when the alveolar structure is curved in a first radius of curvature that is oriented upward and arranged in a first plane, this tends to create a radius of curvature that is oriented downward and arranged in a plane that is essentially perpendicular to the first, whereby the alveolar structure assumes the shape of a saddle or a hyperbolic paraboloid.

These shaping difficulties also originate from the nature of the connection between the alveolar structure and the layers that is not elastic. Thus, whereby the honeycomb is manufactured flat under stress, its shaping embrittles it.

In all of the cases, the shaping of the complex that is used as a coating for acoustic treatment requires complex and expensive equipment and requires a consistent cycle time.

According to another problem, even if the complex is curved, the existing solution would not be satisfactory because the shaping entrains random deformations of the side walls of the tubes of the alveolar structure so that it is difficult to determine the positioning of said side walls of the tubes, whereby the latter are hidden by the reflective and acoustically resistive layers.

Taking into account the difficulties for shaping the complex, the extent of the acoustically treated surfaces is limited at the interior of the tubes of the nacelle, whereby said treated surfaces do not extend at the level of the rim of the air intake of a nacelle.

Also, the purpose of this invention is to overcome the drawbacks of the prior art by proposing a process for the production of a coating for acoustic treatment integrating an alveolar structure that makes it possible for said coating to be able to be shaped along a complex surface without altering its mechanical characteristics, whereby said coating has a simple design and production costs that are suited to the market.

For this purpose, the invention has as its object a process for the production of a coating for acoustic treatment relative to an aircraft surface that is to be treated, in particular at a leading edge such as an air intake of an aircraft nacelle, whereby said coating for the acoustic treatment comprises—from the inside to the outside—a reflective layer, an alveolar structure and an acoustically resistive layer, characterized in that it consists in:

Digitizing the shape of the alveolar structure that it will have when it will be installed at the surface to be treated,

Positioning in a virtual manner—so as to define their geometries—a first series of first non-secant bands that are spaced apart, and at least one second series of second non-secant bands that are spaced apart, whereby the first bands are secant with the second bands so as to delimit a tube between, on the one hand, two first adjacent bands, and, on the other hand, two second adjacent bands,

Cutting out each band according to their geometries defined above,

Producing cut-outs in each band to allow the assembly of said bands,

Assembling the bands so as to obtain an alveolar structure that has shapes that are suited to the surface to be treated, and

Installing the reflective layer and the acoustically resistive layer (32).

According to the invention, using the shapes and cut-outs of the first and second bands, a structure according to a non-plane geometry with a complex profile that is suited to the shape of the surface to be treated is obtained after said bands are assembled. Consequently, contrary to the alveolar structures of the prior art, the alveolar structure of the invention is not deformed once it is assembled.

Other characteristics and advantages will emerge from the following description of the invention, a description that is provided only by way of example, with regard to the accompanying drawings, in which:

FIG. 1 is a perspective view of a propulsion unit of an aircraft,

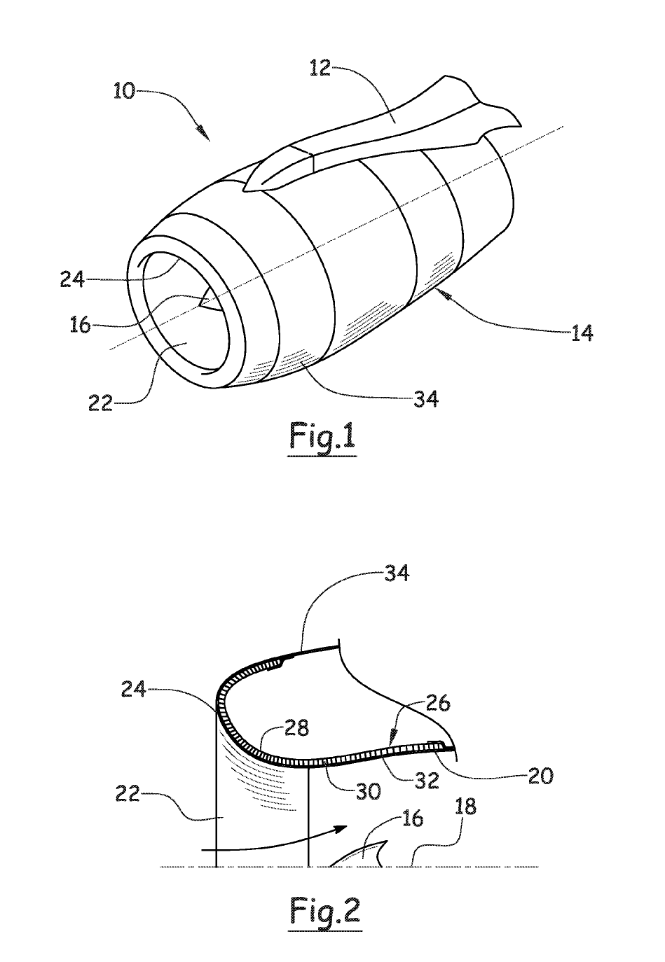

FIG. 2 is a longitudinal cutaway that illustrates an air intake of a nacelle that comprises a coating for acoustic treatment according to the invention,

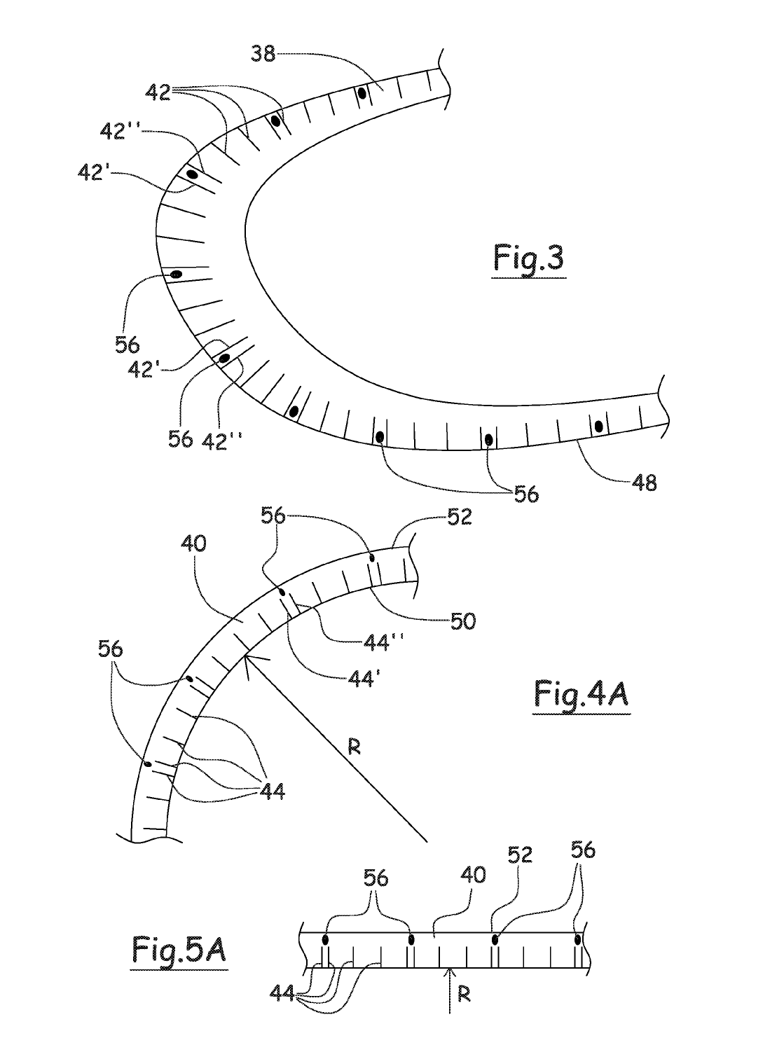

FIG. 3 is an elevation view that illustrates a longitudinal band that is arranged in a radial plane,

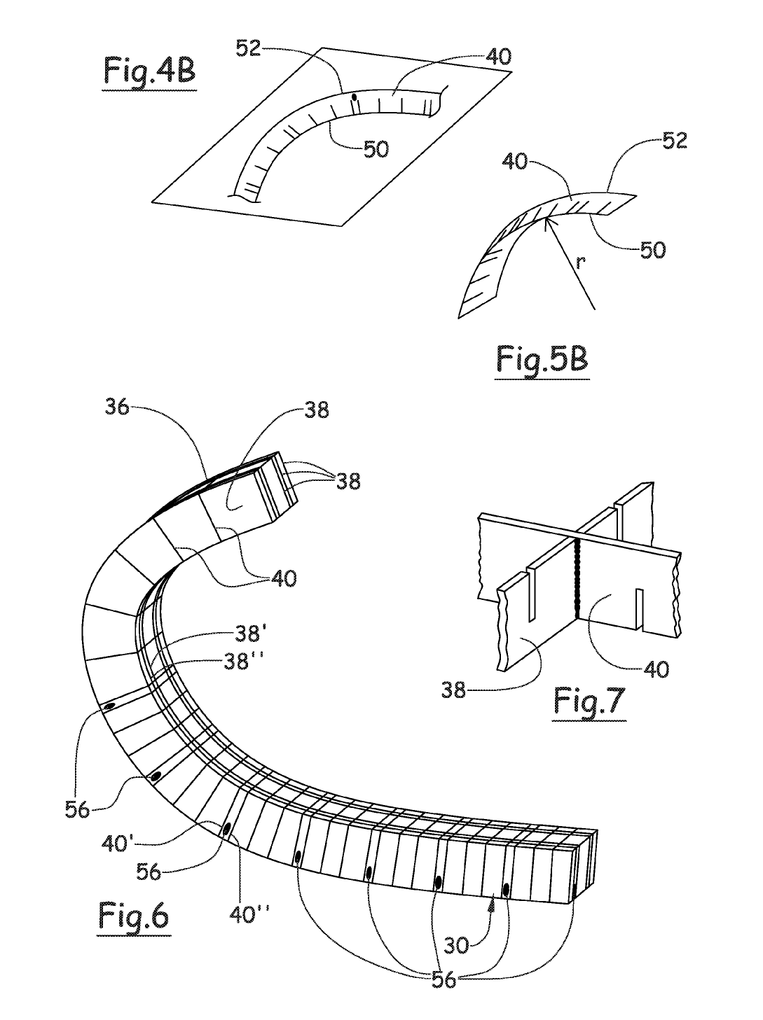

FIG. 4A is an elevation view that illustrates a first transverse band that is arranged along a first surface that is secant with the radial planes,

FIG. 4B is a perspective view that illustrates the first band that is illustrated in FIG. 4A,

FIG. 5A is an elevation view that illustrates a second transverse band that is arranged along a second surface that is secant with the radial planes, whereby said second surface follows the top part of the rim of a nacelle air intake,

FIG. 5B is a perspective view that illustrates the second band that is illustrated in FIG. 5A, which can be curved to overlap with the first bands,

FIG. 6 is a perspective view that illustrates an alveolar structure according to the invention that can be adapted to an angular sector of an air intake,

FIG. 7 is a perspective view that illustrates in detail the connection between a longitudinal band and a transverse band,

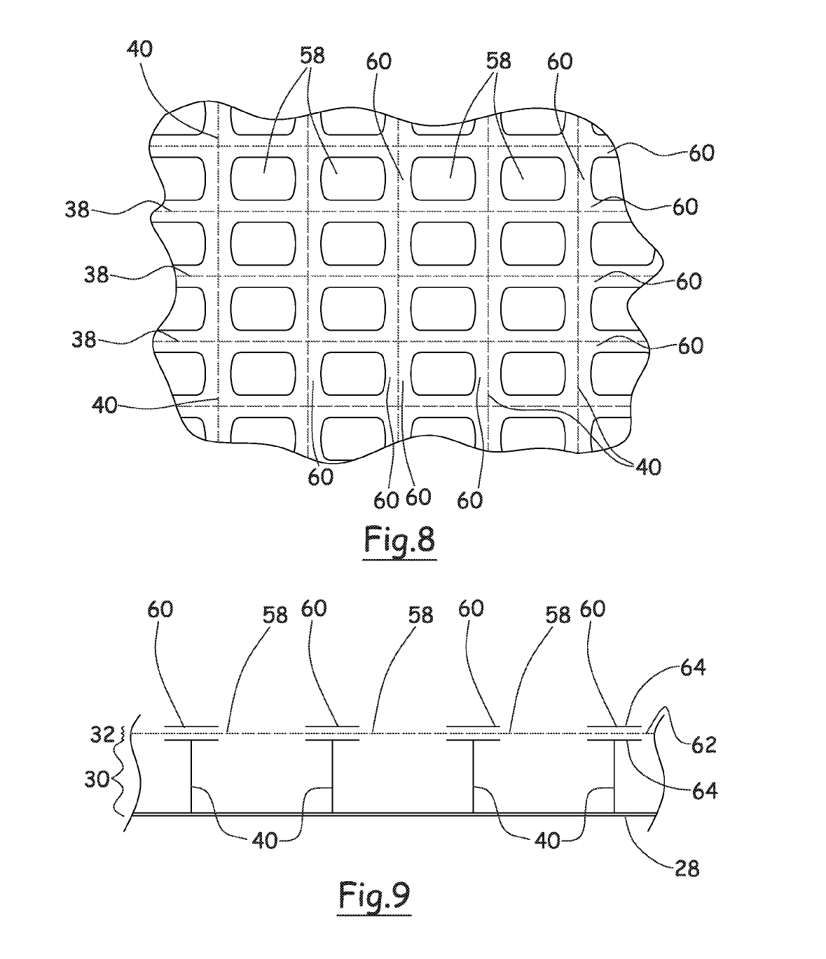

FIG. 8 is a top view that illustrates a coating according to the invention, and

FIG. 9 is a cutaway that illustrates a coating according to the invention.

This invention is now described applied to an air intake of a propulsion unit of an aircraft. However, it can be applied to different leading edges of an aircraft or to different surfaces of an aircraft where an acoustic treatment is performed.

In FIG. 1, a propulsion unit 10 of an aircraft that is connected under the wing by means of a mast 12 is shown. However, this propulsion unit could be connected to other zones of the aircraft.

This propulsion unit comprises a nacelle 14 in which a power plant that drives a fan that is mounted on its shaft 16 is arranged approximately concentrically. The longitudinal axis of the nacelle is referenced 18.

The nacelle 14 comprises an inside wall 20 that delimits a tube with an air intake 22 to the front, whereby a first portion of the entering air flow, called primary flow, passes through the power plant to assist the combination, and whereby the second portion of the air flow, called secondary flow, is driven by the fan and flows into an annular tube that is delimited by the inside wall 20 of the nacelle and the outside wall of the power plant.

The top part 24 of the air intake 22 describes an approximately circular shape that extends into a plane that may be approximately perpendicular to the longitudinal axis 18, as illustrated in FIG. 2, or not perpendicular, with the top part located at slightly past 12 o'clock. However, other air intake shapes can be considered.

Hereinafter, aerodynamic surface is defined as the shell of the aircraft that is in contact with the aerodynamic flow.

To limit the noise impact, a coating 26 whose purpose is to absorb a portion of the sound energy, in particular by using the principle of the Helmholtz resonators, is provided in particular at the aerodynamic surfaces. In a known way, this acoustic coating, also called acoustic panel, comprises—from the inside to the outside—a reflective layer 28, an alveolar structure 30, and an acoustically resistive layer 32.

As a variant, the acoustic coating can comprise several alveolar structures 30 that are separated by acoustically resistive layers that are called a septum.

Layer is defined as one or more layers that may or may not be of the same nature.

According to one embodiment, the reflective layer 28 can come in the form of sheet metal or a skin that consists of at least one layer of woven fibers or non-woven fibers that are immersed in a resin matrix.

The acoustically resistive layer 32 can come in the form of at least one layer of woven or non-woven fibers, whereby the fibers are preferably coated with a resin to ensure the absorption of stresses in the different directions of the fibers.

According to another embodiment, the acoustically resistive structure 32 comprises at least one porous layer in the form of, for example, a fabric that may or may not be metal, such as a wire mesh, and at least one structural layer, for example, sheet metal or a composite with oblong holes or microperforations.

The reflective layer and the acoustically resistive layer are not presented in more detail because they are known to one skilled in the art.

The alveolar structure 30 corresponds to a volume that is delimited by, on the one hand, a first imaginary surface 34 to which the reflective layer 28 is connected, and, on the other hand, a second imaginary surface 36, to which the acoustically resistive layer 32 is connected, as illustrated in FIG. 6.

The distance that separates the first imaginary surface 34 and the second imaginary surface 36 cannot be constant. Thus, this distance can be more significant at the rim of the air intake so as to impart to said structure a greater strength, in particular compression strength.

The alveolar structure 30 comprises, on the one hand, a number of first bands 38 called longitudinal bands that correspond to the intersection of the volume with radial planes incorporating the longitudinal axis 18, and, on the other hand, a number of second bands 40 called transverse bands that correspond to the intersection of the volume with surfaces that are secant with the radial planes. Preferably, at each point of intersection with the second imaginary surface 36, each transverse band 40 is approximately perpendicular to the tangent at the second imaginary surface 36 at the point under consideration.

Preferably, at each point of intersection with the transverse bands 40, each longitudinal band 38 is approximately perpendicular to the tangent of each transverse band 40 at the point under consideration.

Secant surface is defined as a plane or a surface that is secant with the first imaginary surface 34 and with the second imaginary surface 36.

More generally, the alveolar structure comprises a series of first bands 38 that are arranged at the secant surfaces, whereby said first non-secant bands 38 are spaced apart, and at least one second series of second bands 40 is arranged at secant surfaces, whereby said second non-secant bands 40 are spaced apart. The first bands 38 are secant with the second bands so as to delimit a tube between, on the one hand, two first adjacent bands, and, on the other hand, two second adjacent bands.

It is possible to consider more than two series of bands.

However, so as to simplify the design, two series of bands are selected. Thus, tubes with four lateral surfaces are obtained.

Likewise, to simplify the design, the first bands will be arranged in radial planes that contain the longitudinal axis of the nacelle.

To obtain a more rigid structure, the second bands will be arranged so that they are approximately perpendicular to the first bands so as to obtain tubes with square or rectangular sections. This solution also makes it possible to simplify the design. However, other cross-section shapes, for example, diamond-shaped, could be considered.

At the curved zones, the cross-sections of the tubes are tapered. Thus, they vary between a large section at the second imaginary surface 36 and a smaller section at the first imaginary surface 34.

To assemble the bands of the different series that intersect, first cut-outs 42 are provided at the longitudinal bands 38 that work with second cut-outs 44 at the transverse bands 40.

The first and second cut-outs 42 and 44 do not extend from one edge to the next to facilitate the assembly.

The length of the first cut-outs 42 and that of the second cut-outs 44 are adjusted so that the edges of the longitudinal bands and transverse bands are arranged at imaginary surfaces 34 and 36.

According to one embodiment, the first cut-outs 42 extend from the edge of the longitudinal bands arranged at the second imaginary surface 36. In addition, the second cutouts 44 extend from the edge of the transverse bands arranged at the first imaginary surface 34.

According to one embodiment, the shape of the alveolar structure 30 that it will have when it is installed at the surface to be treated is digitized. The longitudinal and transverse bands are then positioned virtually so as to define the geometries for each of them. It is possible to make the surface area discrete using the same method as networking software. Making the surface area discrete is done by projection of geometries.

Thus, as illustrated in FIG. 3, in the case of an air intake, the longitudinal bands 38 have a C shape with a first edge 46 that is able to correspond to the first imaginary surface 34 and a second edge 48 that can correspond to the second imaginary surface 36. According to the variants, the distance that separates the edges 46 and 48 can vary from one band to the next or along the profile of the same band. The longitudinal bands 38 are cut out into essentially flat plates. This flat cutout simplifies production. Furthermore, the shapes of the imaginary surfaces 34 and 36 originate from the shapes of the edges 46 and 48 that are generated by cutting and not by deformation, which ensures a greater dimensional precision of said imaginary surfaces.

To the extent where the longitudinal bands 38 are arranged in radial planes, they are not curved during the assembly with the transverse bands 40.

As illustrated in FIGS. 4A, 4B, 5A and 5B, in the case of an air intake, the transverse bands 40 have ring shapes with a first edge 50 that can correspond to the first imaginary surface 34 and a second edge 52 that can correspond to the second imaginary surface 36. The edges 50 and 52 have a radius of curvature that is able to vary gradually, based on the removal with the top part 24, from a value R that corresponds approximately to the radius of curvature of the tube that forms the nacelle for the transverse bands 40, as illustrated in FIG. 4A, and an infinite radius, whereby the edges 50 and 52 are approximately rectilinear, for the transverse band 40 that is arranged at the top part 24 of the air intake, as illustrated in FIG. 5A.

The transverse bands 40 are cut out into essentially flat plates.

One advantage of the invention resides in the fact that the transverse and longitudinal bands are cut out flat, which contributes to simplifying the production, and they do not undergo any shaping operation, which ensures the adjustment of cells on the reflective layer and the acoustically resistive layer.

The transverse bands, based on their position, are flexible enough to be able to be optionally curved so as to overlap in the longitudinal bands. As illustrated in FIG. 4B, the transverse bands 40 that are arranged in zones of the alveolar structure that have a single radius of curvature, in particular the approximately cylindrical parts, are arranged in planes once assembled.

The majority of the transverse bands 40 are flexible enough to be optionally curved along a radius of curvature r that is perpendicular to the surface of the bands, as illustrated in FIG. 5B, based on their position at the alveolar structure. Thus, the transverse bands 40 that are removed from the top part 24 are not curved, which corresponds to an infinite radius of curvature r, whereby the transverse bands 40 have a radius of curvature r that gradually decreases based on the distance that separates the transverse band under consideration of the top part 24 up to a radius r that is approximately equal to the radius of the top part for the transverse band 40, illustrated in FIGS. 5A and 5B, arranged at the top part 24.

According to an important advantage of the invention, the bands are no longer deformed once assembled or when the reflective or acoustically resistive layers are installed.

Whereby the thus constituted acoustic coating has shapes suited to those of the surface to be treated, it is no longer deformed during its installation at said surface to be treated. Consequently, contrary to the prior art, the connection between the alveolar structure and the reflective layer or the acoustically resistive layer no longer runs the risk of being damaged, and the position of the walls of the tubes that correspond to the bands is perfectly known and corresponds to the desired position during the digitization.

According to one embodiment, the bands 38 and 40 can be made of cardboard, metal (titanium, steel alloy of aluminum), or composite (glass fibers, for example). It is optionally possible to mix the materials that are used, for example to use glass fibers for the longitudinal bands and titanium for the transverse bands.

Advantageously, metal will be selected to impart to the structure a good resistance to impacts, in particular to bird strikes.

According to the variants, the assembly of bands can be manual or robotized.

As illustrated in FIG. 7, the longitudinal bands 38 and the transverse bands 40 are assembled and then connected to one another by welding, for example a brazing 54, or by gluing. However, other solutions for ensuring a connection between the bands can be considered.

According to one advantage of the invention, it is possible to vary the thickness of the alveolar structure. Thus, the parts of the alveolar structure that are arranged facing the rim have a thickness that is greater than the parts of the alveolar structure that are removed from said rim.

According to the variants, the edges of the bands can have more complex shapes and comprise several radii of curvature so as to obtain more complex surfaces.

If appropriate, it is possible to vary the spacing between the bands of the same series.

Thus, the first consecutive cut-outs 42′ and 42″ can have a smaller spacing so as to obtain a slight spacing between the consecutive transverse bands 40′ and 40″ as illustrated in FIG. 6. Likewise, the second consecutive cut-outs 44′ and 44″ can have a smaller spacing so as to obtain a slight spacing between the consecutive longitudinal bands 38, 38″ as illustrated in FIG. 6.

This arrangement makes it possible to obtain cells with variable sections.

According to another improvement, the bands 38 and 40 can comprise cut-outs 56 for linking certain cells to one another and for obtaining a network of tubes. This solution makes it possible to generate a network of tubes, located between the consecutive bands 38 and 40 that are brought close together and are used to channel hot air and to provide the frost treatment function.

The non-communicating cells are used for the function of acoustic treatment.

This configuration makes it possible to make the functions of frost treatment and acoustic treatment compatible, whereby certain coating cells, those that do not communicate with one another, are provided exclusively for acoustic treatment and others, those that communicate with one another, exclusively for the frost treatment.

According to an embodiment that is illustrated in FIGS. 8 and 9, the acoustically resistive layer 32 comprises at least one skin with open zones 58 that allow sound waves to pass and filled zones 60 that do not allow the sound waves to pass. The shape, the dimensions, the number, and the arrangement of open zones 58 are adjusted so as to optimize the acoustic treatment by minimizing the disruptions at the aerodynamic flow that flows onto the surface of said acoustically resistive layer.

By way of example, the open zones 58 can have an oblong shape whose largest dimension is used in the direction of the flow of the aerodynamic flow.

According to the variants, an open zone 58 comprises a single opening whose shape corresponds to that of the open zone or a number of slightly spaced holes or microperforations that cover said open zone.

According to another embodiment, the acoustically resistive structure 32 comprises at least one porous layer in the form of, for example, a fabric that may or may not be metal, such as a wire mesh, and at least one structural layer, for example, sheet metal or a composite with open zones 58.

The acoustically resistive layer can comprise other holes, perforations or microperforations for the treatment of frost by hot air, for example.

According to a characteristic of the invention, the acoustically resistive layer 32 is produced by using open zones 58 based on the position of the side walls 38 and 40 of the alveolar structure 30.

Optionally, during the production of the open zones 58, the acoustically resistive layer 32 is deposited on a preform whose shapes correspond to those of the surface of the alveolar structure 30 on which said acoustically resistive layer 32 is to be placed so as to obtain a better positioning of the open zones 58.

When the acoustically resistive layer 32 and the alveolar structure 30 are produced, they are assembled by any suitable means. By way of example, the alveolar structure is metal, and the acoustically resistive layer 32 comprises a wire mesh 62 that is arranged between two metal structural layers 64, whereby one of the two structural layers 64 is connected to the alveolar structure by welding or by gluing. As a variant, the acoustically resistive layer consists of sheet metal with microperforations at the open zones 58.

According to the invention, a perfect positioning of the open zones 58 relative to the side walls 38 and 40 of the alveolar structure 30 is achieved, whereby said open zones 58 are never arranged facing a side wall but rather facing a cell. Thus, the operation of the opening is always optimal for the acoustic treatment. Consequently, the ratio of open surface area is determined precisely without providing a margin of error due to a poor positioning of open zones relative to the side walls. Thus, the acoustically resistive layer of the invention is also optimal in terms of aerodynamic characteristics to the extent that the open zones that are provided ensure optimum operation in terms of acoustic treatment, whereby none of said zones is provided facing a side wall.

1. Process for the production of a coating for acoustic treatment relative to an aircraft surface that is to be treated, in particular at a leading edge such as an air intake of an aircraft nacelle, whereby said coating for the acoustic treatment comprises—from the inside to the outside—a reflective layer (28), an alveolar structure (30), and an acoustically resistive layer (32), which comprises:
Digitizing the shape of the alveolar structure (30) that it will have when it will be installed at the surface to be treated,
Positioning in a virtual manner—so as to define their geometries—a first series of first non-secant bands (38) that are spaced apart, and at least one second series of second non-secant bands (40) that are spaced apart, whereby the first bands (38) are secant with the second bands (40) so as to delimit a tube between, on the one hand, two first adjacent bands (38), and, on the other hand, two second adjacent bands (40),
Cutting out each band (38, 40) according to their geometries defined above,
Producing cut-outs (42, 44) in each band (38, 40) to allow the assembly of said bands (38, 40),
Assembling the bands (38, 40) so as to obtain an alveolar structure that has shapes that are suited to the surface to be treated, and
Installing the reflective layer (28) and the acoustically resistive layer (32).

2. Process for the production of a coating for acoustic treatment according to claim 1, further comprising arranging the first so-called longitudinal bands in radial planes that contain the longitudinal axis (18) of the nacelle.

3. Process for the production of a coating for acoustic treatment according to claim 1, further comprising consists in arranging each second band (40) called a transverse band essentially perpendicular to the tangent of an imaginary surface (36) to which the acoustically resistive layer (32) is connected.

4. Process for the production of a coating for acoustic treatment according to claim 3, further comprising arranging each longitudinal band (38) essentially perpendicular to the tangent of each transverse band (40).

5. Process for the production of a coating for acoustic treatment according to claim 1, further comprising making cut-outs or openings (56) in the first bands called longitudinal bands (38) and the second bands called transverse bands (40) to link certain tubes to one another so as to obtain a network of tubes provided for the frost treatment, whereby the non-communicating tubes are provided for the acoustic treatment.

6. Process for the production of a coating for acoustic treatment according to claim 1, further comprising producing open zones (58) at the acoustically resistive layer (32) based on the positioning of the bands (38, 40).

7. Coating for the acoustic treatment that is obtained from the process according to claim 1, wherein said coating comprises at least one alveolar structure (30) that comprises a series of first non-secant bands (38) that are spaced apart, and at least one second series of second non-secant bands (40) that are spaced apart, and wherein the first bands (38) are secant with the second bands (40) so as to delimit a tube between, on the one hand, two first adjacent bands (38), and, on the other hand, two second adjacent bands (40), wherein the first and second bands (38, 40) have shapes and cut-outs (42, 44) so as to allow an assembly of said bands according to a non-plane geometry in accordance with the shape of the alveolar structure (30) that is installed at the surface to be treated.

8. Aircraft nacelle that incorporates a coating for acoustic treatment according to claim 7.

9. Process for the production of a coating for acoustic treatment according to claim 2, further comprising wherein it consists in arranging each second band (40) called a transverse band essentially perpendicular to the tangent of an imaginary surface (36) to which the acoustically resistive layer (32) is connected.

10. Process for the production of a coating for acoustic treatment according to claim 9, further comprising arranging each longitudinal band (38) essentially perpendicular to the tangent of each transverse band (40).
